(19) United States
(12) Patent Application Publication
(10) Pub. No.: US 2023/0170681 A1
(43) Pub. Date: Jun. 1, 2023

(54) WIRE HARNESS

(71) Applicant: SUMITOMO WIRING SYSTEMS, LTD., Yokkaichi-shi (JP)

(72) Inventors: Ryuta SAITO, Yokkaichi-shi (JP); Katsutoshi IZAWA, Yokkaichi-shi (JP); Kosuke TANAKA, Yokkaichi-shi (JP)

(73) Assignee: SUMITOMO WIRING SYSTEMS, LTD., Yokkaichi-shi (JP)

(21) Appl. No.: 17/990,039

(22) Filed: Nov. 18, 2022

(30) Foreign Application Priority Data
Nov. 26, 2021 (JP) 2021-192256

(51) Int. Cl. H02G 3/32; H02G 3/04; B60R 16/02

(52) U.S. Cl. CPC H02G 3/32; H02G 3/0468; H02G 3/0481; B60R 16/0215

(57) ABSTRACT

A wire harness including: an electrical wire; and a fixing member that fixes the electrical wire to an attachment target, wherein: the fixing member has: a bolt fixing portion to be fixed to a bolt of the attachment target; and a holder that holds the electrical wire, the bolt fixing portion includes: a fixing portion body; and a fitting that is assembled to the fixing portion body, the fixing portion body has: an insertion hole through which the bolt is to be inserted; and a fitting hole that communicates with the insertion hole and into which the fitting is fitted, the insertion hole has a first engagement that engages a thread of the bolt in an axial direction, and the fitting has a second engagement that engages the thread of the bolt in the axial direction.

### BACKGROUND

The present disclosure relates to a wire harness.

A wire harness of JP 2006-46508A, for example, includes a fixing member that fixes a wire member to a vehicle body. The fixing member has a holding portion that holds the wire member and a bolt fixing portion that is fixed to a bolt provided on the vehicle body. The bolt fixing portion has an engaging piece that engages a threaded portion of the bolt in the axial direction. At least a pair of engaging pieces are provided so as to sandwich the bolt in a direction orthogonal to the axial direction. When assembling the fixing member to the bolt, the bolt is inserted into the fixing member. At this time, the engaging pieces flex in a direction away from each other due to being pushed by the bolt. The engaging pieces are then biased toward the bolt by their elasticity and engage the threaded portion of the bolt.

### SUMMARY

With a wire harness such as described above, the engaging pieces move in a direction away from each other when the weight of the wire member, the fixing member and the like increases, giving rise to the possibility that the fixing member will come off the bolt.

An exemplary aspect of the disclosure provides a wire harness designed to inhibit detachment of a fixing member from a bolt.

A wire harness of the present disclosure is a wire harness including an electrical wire; and a fixing member that fixes the electrical wire to an attachment target, wherein: the fixing member has: a bolt fixing portion to be fixed to a bolt of the attachment target; and a holder that holds the electrical wire, the bolt fixing portion includes: a fixing portion body; and a fitting that is assembled to the fixing portion body, the fixing portion body has: an insertion hole through which the bolt is to be inserted; and a fitting hole that communicates with the insertion hole and into which the fitting is fitted, the insertion hole has a first engagement that engages a thread of the bolt in an axial direction, and the fitting has a second engagement that engages the thread of the bolt in the axial direction.

According to the present disclosure, it becomes possible to inhibit detachment of a fixing member from a bolt.

### BRIEF DESCRIPTION OF THE DRAWINGS

FIG. 1 is a schematic configuration diagram showing a wire harness of an embodiment;

FIG. 2 is a schematic cross-sectional view showing the wire harness of the embodiment;

FIG. 3 is a schematic exploded perspective view showing the wire harness of the embodiment;

FIG. 4 is a schematic side view showing the configuration in the vicinity of a bolt fixing portion in an enlarged manner in the wire harness of the embodiment;

FIG. 5 is a schematic side view showing the configuration in the vicinity of the bolt fixing portion in an enlarged manner in the wire harness of an example modification;

FIG. 6 is a schematic perspective view showing a fitting part in the wire harness of an example modification; and

FIG. 7 is a schematic cross-sectional view of the wire harness of the example modification.

### DETAILED DESCRIPTION OF EMBODIMENTS

### Description of Embodiments of the Disclosure

Initially, embodiments of the disclosure will be enumerated and described.

A wire harness of the present disclosure is:

[1] A wire harness including a wire member having an electrical wire, and a fixing member that fixes the wire member to an attachment target, the fixing member having a bolt fixing portion to be fixed to a bolt of the attachment target and a holding portion that holds the wire member, the bolt fixing portion including a fixing portion body and a fitting part that is assembled to the fixing portion body, the fixing portion body having an insertion hole through which the bolt is to be inserted and a fitting hole that communicates with the insertion hole and into which the fitting part is fitted, the insertion hole having a first engaging portion that engages a threaded portion of the bolt in an axial direction, and the fitting part having a second engaging portion that engages the threaded portion of the bolt in the axial direction.

According to this configuration, the fixing member is fixed to the bolt, due to the first engaging portion of the fixing portion body and the second engaging portion of the fitting part that is assembled to the fixing portion body engaging the bolt. The first engaging portion and the second engaging portion thereby no longer need to be constituted to readily flex in a direction away from each other while contacting the bolt as in the conventional structure, and, as a result, it becomes possible to inhibit detachment of the fixing member from the bolt.

[2] The first engaging portion may have an undulating structure provided on a side surface of the insertion hole, and the second engaging portion may have an undulating structure provided on a side surface of the fitting part.

According to this configuration, the first engaging portion and the second engaging portion each engage the bolt with an undulating structure. It thus becomes possible for the first engaging portion and the second engaging portion to be firmly engaged with the bolt.

[3] The first engaging portion and the second engaging portion may be provided at positions opposing each other across the bolt.

According to this configuration, the first engaging portion and the second engaging portion are engaged on either side of the bolt, and thus it becomes possible for the first engaging portion and the second engaging portion to be stably engaged with the bolt.

[4] The fitting part may be press-fit into the fitting hole.

According to this configuration, the fitting part is firmly fitted into the fitting hole. Accordingly, it becomes possible for the first engaging portion and the second engaging portion to be firmly engaged with the bolt.

[5] The fitting part may be separate from the fixing portion body.

According to this configuration, the fitting part is separate from the fixing portion body, and thus the task of fitting the fitting part into the fitting hole can be performed more easily.

[6] The fitting part may be joined to the fixing portion body by a hinge part.

According to this configuration, the fixing portion body and the fitting part can be configured as one component, and thus it becomes possible to suppress an increase in the number of components.

[7] The wire harness may include an exterior member covering an outer periphery of the wire member, and a path regulating member attached to an outer periphery of the exterior member and regulating a path of the exterior member, and the path regulating member may have an insertion opening open in a direction orthogonal to a length direction of the path regulating member and extending over an entirety of the path regulating member in the length direction.

According to this configuration, given that the exterior member covering the wire member and the path regulating member that is attached to the outer periphery of the exterior member are provided, the wire harness tends to become heavier. It thus becomes possible to more markedly obtain the effect of inhibiting detachment of the fixed member achieved by the above configuration.

[8] The holding portion may hold the path regulating member in a manner covering an entire circumference of the path regulating member, the holding portion may have a protrusion protruding on an inner peripheral side, and the protrusion may be positioned inside the insertion opening. According to this configuration, rotation of the path regulating member relative to the holding portion can be regulated by the protrusion of the holding portion.

[9] The fitting part may have a circular arc recessed portion recessed in a circular arc shape as seen from the axial direction of the bolt, and the second engaging portion may be provided in the circular arc recessed portion.

According to this configuration, the second engaging portion is provided in a circular arc recessed portion, and thus it becomes possible to increase the contact area between the bolt and the second engaging portion. As a result, it becomes possible for the second engaging portion to be firmly engaged with the bolt.

### DETAILED DESCRIPTION OF EMBODIMENTS OF THE DISCLOSURE

Specific examples of a wire harness of the present disclosure will be described below with reference to the drawings. In the individual diagrams, parts of the configuration may be shown in an exaggerated or simplified manner, for convenience of description. Also, the dimensional ratios of various portions may differ between the individual diagrams. Also, “orthogonal” herein is not only strictly orthogonal but also includes generally orthogonal within a range that achieves the operation and effect of the present embodiment.

Note that “opposing” herein refers to two surfaces or members being positioned in front of each other, and includes not only the case where the two portions are perfectly in front of each other but also the case where the two portions are partially in front of each other. Also, “opposing” herein includes both the case where another member other than the two portions is interposed between the two portions and the case where another member is not interposed between the two portions.

### Overall Configuration of Wire Harness 10

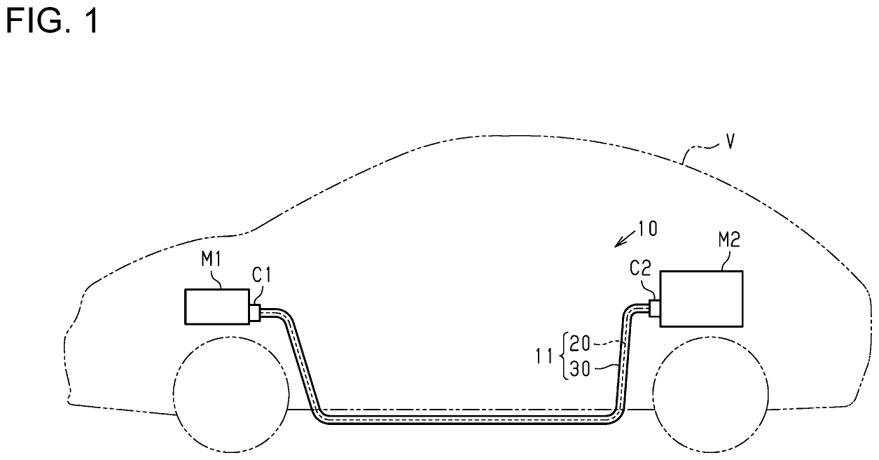

A wire harness 10 shown in FIG. 1 is installed in a vehicle V such as a hybrid vehicle or an electric vehicle, for example. The wire harness 10 electrically connects two or more in-vehicle devices to each other. The in-vehicle devices are electrical devices installed in the vehicle V. The wire harness 10 electrically connects an inverter M1 installed in a front part of the vehicle V to a high voltage battery M2 installed more rearwardly in the vehicle V than the inverter M1. The wire harness 10 is formed in a long shape so as to extend in the front-rear direction of the vehicle V, for example. The wire harness 10 is routed in the vehicle V such that an intermediate portion of the wire harness 10 in the length direction passes outside the vehicle cabin such as under the floor of the vehicle V, for example.

The inverter M1 is, for example, connected to a motor for driving wheels not shown that serves a power source for vehicle travel. The inverter M1 generates AC power from DC power of the high voltage battery M2 and supplies the generated AC power to the motor. The high voltage battery M2 is, for example, a battery capable of supplying a voltage of several hundred volts.

The wire harness 10 has a wire harness body 11. The wire harness body 11 includes a wire member 20 and a tubular exterior member 30 (exterior tube) that covers the outer periphery of the wire member 20. The wire harness 10 has connectors C1 and C2 attached to either end portion of the wire member 20. One end portion of the wire member 20 in the length direction is connected to the inverter M1 via the connector C1, and the other end portion of the wire member 20 in the length direction is connected to the high voltage battery M2 via the connector C2.

### Configuration of Wire Member 20

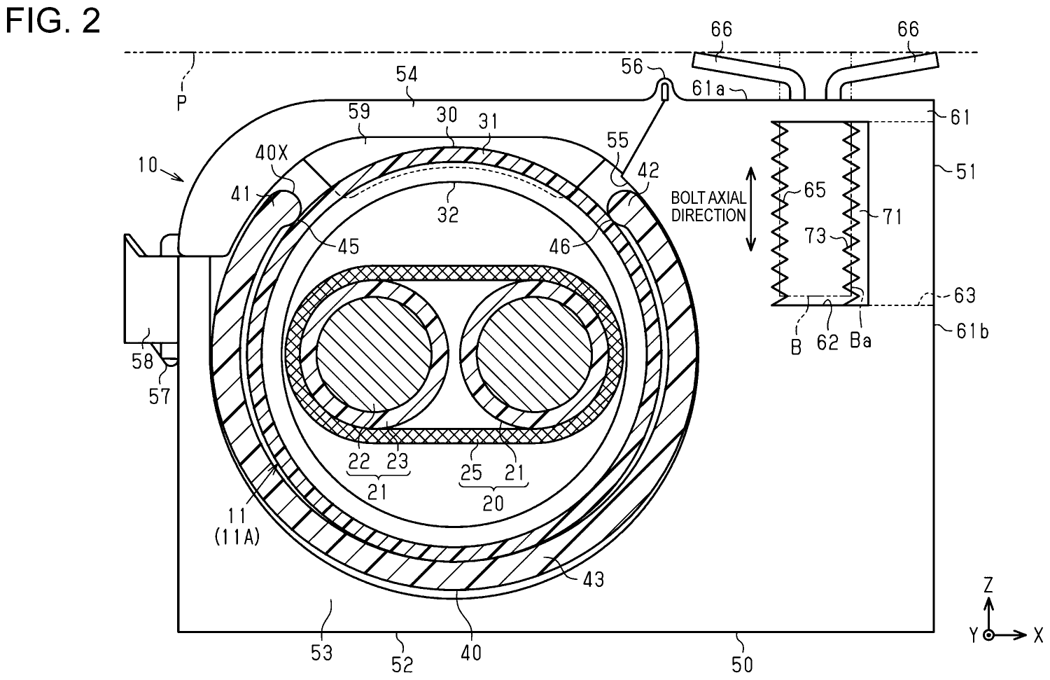

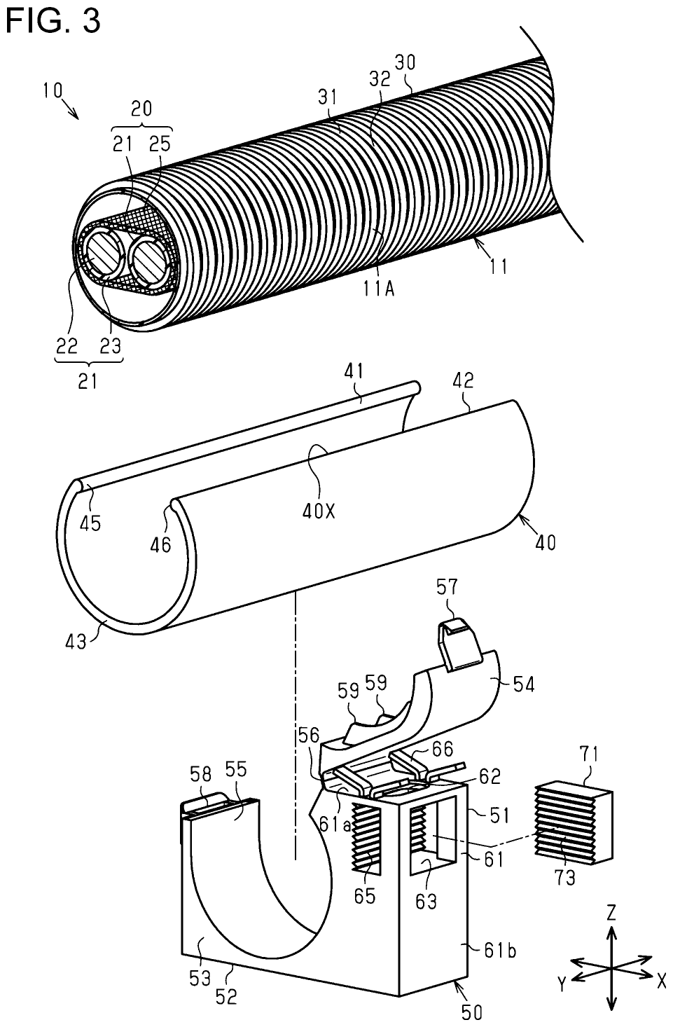

As shown in FIGS. 2 and 3, the wire member 20 has, for example, one or a plurality of electrical wires, being two electrical wires 21 in the present embodiment, and a braided member 25 that collectively encloses the outer periphery of the plurality of wires 21.

As shown in FIG. 2, the wires 21 are coated wires having a core wire 22 that has conductivity and an insulation coating 23 that has insulating properties and surrounds the outer periphery of the core wire 22. The wires 21 are, for example, high voltage wires capable of handling high voltages and large currents. The wires 21 may, for example, be unshielded wires that do not have their own electromagnetic shield structure, or be shielded wires that have their own electromagnetic shield structure. The wires 21 of the present embodiment are unshielded wires.

As the core wire 22, a twisted wire formed by twisting together a plurality of metal wire strands or a single core wire formed from a single conductor can be used, for example. As the single core wire, a columnar conductor formed from a single columnar metal rod having a solid structure internally or a tubular conductor having a hollow structure internally can be used, for example. As the core wire 22, a twisted wire, a columnar conductor and a tubular conductor may also be used in combination. As the material of the core wire 22, a metal material such as a copper-based or aluminum-based material can be used, for example.

The insulation coating 23 covers the entire circumference of the outer peripheral surface of the core wire 22 in the circumferential direction, for example. The insulation coating 23 is constituted by a resin material having insulating properties, for example. The cross-sectional shape obtained by cutting the wires 21 by a plane orthogonal to the length direction of the wires 21, that is, the transverse sectional shape of the wires 21, can be formed in any shape. The transverse sectional shape of the wires 21 is formed in a circular shape, a semi-circular shape, a polygonal shape, a square shape or a flat shape, for example. The transverse sectional shape of the wires 21 of the present embodiment is formed in a circular shape.

The braided member 25 has a tubular shape that collectively encloses the outer periphery of the plurality of wires 21 as a whole, for example. As the braided member 25, a braided wire in which a plurality of metal wire strands are braided or a braided wire in which metal and resin wire strands are braided together can be used, for example. As the material of the metal wire strands, a metal material such as a copper-based or aluminum-based metal material can be used, for example. Although not illustrated, both end portions of the braided member 25 in the length direction are grounded at the connectors C1 and C2 (see FIG. 1), for example.

### Configuration of Exterior Member 30

As shown in FIG. 3, the exterior member 30 has a tubular shape that encloses the entire circumference of the outer periphery of the wire member 20 in the circumferential direction. The exterior member 30 of the present embodiment is formed in a tubular shape. The exterior member 30 is formed as a peripheral wall to continuously span the entire circumference of the exterior member 30 in the circumferential direction, for example. The exterior member 30 seals the inside of the exterior member 30 around the entire circumference in the circumferential direction, for example. The exterior member 30 has a function of protecting the wire member 20 from projectiles and water droplets, for example.

The exterior member 30 has flexibility and is easily bendable, for example. Examples of the exterior member 30 having flexibility include a corrugated tube made of resin and a waterproof cover made of rubber, for example. The exterior member 30 of the present embodiment is a resin corrugated tube having a bellows shape constituted by alternating large and small diameter portions in the length direction of the exterior member 30. That is, the exterior member 30 of the present embodiment has a bellows structure in which a large diameter portion 31 and a small diameter portion 32 having a diameter smaller than the large diameter portion 31 are alternately provided continuously in the length direction of the exterior member 30. The large diameter portions 31 and the small diameter portions 32 each have an annular shape completely around the exterior member 30 in the circumferential direction, for example. As the material of the exterior member 30, a synthetic resin such as polyolefin, polyamide, polyester or ABS resin can be used, for example.

### Configuration of Path Regulating Member 40

As shown in FIGS. 2 and 3, the wire harness 10 includes a path regulating member 40 (path regulator) that is attached to the outer periphery of the exterior member 30. The path regulating member 40 regulates the path along which the wire harness body 11 is routed. Note that, in FIG. 1, the path regulating member 40 is not illustrated.

The path regulating member 40 holds the exterior member 30. The path regulating member 40 is, for example, more rigid than the exterior member 30. The path regulating member 40 has a stiffness that is not readily bendable in a direction orthogonal to the length direction of the wire harness body 11, compared to the exterior member 30. The path regulating member 40 thereby regulates the path of the wire harness body 11. For example, the path regulating member 40 supports the exterior member 30, such that the wire harness body 11 does not flex under its own weight and deviate from the desired path. The path regulating member 40 is provided along part of the wire harness body 11 in the length direction. The path regulating member 40 is, for example, attached to the outer periphery of the exterior member 30 in a straight section 11A that is a section of the path of the wire harness body 11 that has a straight shape.

As shown in FIG. 2, the path regulating member 40 covers part of the outer periphery of the exterior member 30 in the circumferential direction of the exterior member 30. The path regulating member 40 has a shape that partially covers the outer periphery of the exterior member 30 in the circumferential direction of the exterior member 30. The transverse sectional shape of the path regulating member 40 is C-shaped as a whole. The path regulating member 40 covers more than half of the outer periphery of the exterior member 30, for example. That is, the path regulating member 40 covers more than half of the entire circumference of the outer periphery of the exterior member 30 in the circumferential direction of the exterior member 30.

The path regulating member 40 extends in the length direction of the exterior member 30 in the straight section 11A. The path regulating member 40 is formed in a shape that extends straight in one direction, for example. The transverse sectional shape of the path regulating member 40 is uniform over the entire length of the path regulating member 40 in the length direction, for example.

The path regulating member 40 is made of metal or resin, for example. The path regulating member 40 of the present embodiment is made of resin. As the material of the path regulating member 40, a synthetic resin such as polypropylene, polyamide or polyacetal can be used, for example. The path regulating member 40 can be manufactured by a known manufacturing method such as extrusion molding or injection molding, for example. In the present embodiment, the path regulating member 40 is an extrusion molded product manufactured by extrusion molding. Therefore, the path regulating member 40 can be easily manufactured, by using an extrusion molding machine that extrudes the raw material of the path regulating member 40 in the length direction. Also, a plurality of types of path regulating members 40 having different dimensions in the length direction can be manufactured using a single extrusion molding machine. For example, a plurality of types of path regulating members 40 having different dimensions in the length direction can be manufactured, by cutting the base material of the path regulating member 40 formed with a single extrusion molding machine at suitable lengths using a cutting machine.

The path regulating member 40 has an insertion opening 40X that is open in a direction orthogonal to the length direction of the path regulating member 40. The insertion opening 40X extends over the entirety of the path regulating member 40 in the length direction. The path regulating member 40 has a first end portion 41 and a second end portion 42 that are respective end portions of the path regulating member 40 in the circumferential direction and form the insertion opening 40X. The path regulating member 40 has a connecting portion 43 that connects the first end portion 41 and the second end portion 42 to each other. In other words, the path regulating member 40 has the connecting portion 43 formed so as to partially cover the exterior member 30 in the circumferential direction, the first end portion 41 and the second end portion 42 provided at respective end portions of the connecting portion 43, and the insertion opening 40X formed by the first end portion 41 and the second end portion 42.

The connecting portion 43 constitutes a main portion of the path regulating member 40. The thickness of the connecting portion 43 in the radial direction is, for example, uniform in the circumferential direction of the path regulating member 40. The transverse sectional shape of the connecting portion 43 is formed in a shape that follows the outer surface of the exterior member 30, for example. The transverse sectional shape of the first end portion 41, the second end portion 42 and the connecting portion 43 is formed in a circular arc shape, for example.

The first end portion 41 and the second end portion 42 are provided on opposite sides to each other in the circumferential direction of the path regulating member 40. The first end portion 41 and the second end portion 42 are provided apart from each other in the circumferential direction of the path regulating member 40 across the insertion opening 40X. In other words, the gap between the first end portion 41 and the second end portion 42 in the circumferential direction of the path regulating member 40 is constituted as the insertion opening 40X. In this way, the path regulating member 40 is formed in a C-shape having the insertion opening 40X in part of the path regulating member 40 in the circumferential direction.

The transverse sectional shape of the distal ends of the first end portion 41 and the second end portion 42 is formed in a curved shape. The transverse sectional shape of the distal ends of the first end portion 41 and the second end portion 42 of the present embodiment is formed in a circular arc shape.

The path regulating member 40 has a protruding portion 45 that protrudes from the inner surface of the first end portion 41 and a protruding portion 46 that protrudes from the inner surface of the second end portion 42. The protruding portions 45 and 46 protrude toward the exterior member 30 inserted inside the path regulating member 40 and contact the outer surface of the exterior member 30. The protruding portions 45 and 46 contact the outer surface of the large diameter portions 31 of the exterior member 30. The protruding portion 45 protrudes from the inner surface of the distal end of the first end portion 41, for example. The protruding portion 46 protrudes from the inner surface of the distal end of the second end portion 42, for example. The transverse sectional shape of the protruding portions 45 and 46 is formed in a curved shape, for example. The transverse sectional shape of the protruding portions 45 and 46 of the present embodiment is formed in a circular arc shape.

As shown in FIG. 3, the protruding portions 45 and 46 extend in the length direction of the path regulating member 40. The protruding portions 45 and 46 extend over the entire length of the path regulating member 40 in the length direction, for example.

The protruding portions 45 and 46 press against the exterior member 30 from the outer side of the exterior member 30. The exterior member 30 is elastically sandwiched by the protruding portion 45, the protruding portion 46 and the connecting portion 43. The path regulating member 40 is thereby firmly connected to the exterior member 30.

As shown in FIG. 2, the opening width of the insertion opening 40X, that is, the shortest distance between the first end portion 41 and the second end portion 42, is smaller than the outer diameter of the exterior member 30.

The opening width of the insertion opening 40X increases due to the path regulating member 40 elastically deforming. For example, the opening width of the insertion opening 40X increases, due to the exterior member 30 being inserted into the insertion opening 40X from a direction orthogonal to the length direction of the path regulating member 40. When the exterior member 30 is inserted inside the path regulating member 40, the path regulating member 40 elasticity returns toward its original shape. Since the opening width of the insertion opening 40X is smaller than the outer diameter of the exterior member 30, the path regulating member 40 is thereby attached to the outer periphery of the exterior member 30.

### Configuration of Fixing Member 50

As shown in FIG. 2, the wire harness 10 includes a fixing member 50 for fixing the wire harness body 11 to a panel P constituting a floor part of the vehicle V. One or a plurality of fixing members 50 are provided in the length direction of the wire harness body 11. Note that the fixing member 50 is not illustrated in FIG. 1. The fixing member 50 holds a region of the wire harness body 11 to which the path regulating member 40 is attached, for example.

The fixing member 50 is made of metal or resin, for example. The fixing member 50 of the present embodiment is made of resin. As the material of the fixing member 50, a synthetic resin such as polypropylene, polyamide or polyacetal can be used, for example. The fixing member 50 can be manufactured by a known manufacturing method such as injection molding, for example.

As shown in FIGS. 2 and 3, the fixing member 50 has a bolt fixing portion 51 that is fixed to a bolt B extending from the panel P, and a holding portion 52 (holder) that holds the wire harness body 11.

### Configuration of Holding Portion 52

The holding portion 52 holds the path regulating member 40 in a manner covering the entire circumference of the path regulating member 40. The holding portion 52 includes a holding portion body 53 and a lid part 54 connected to the holding portion body 53.

The holding portion body 53 covers the outer periphery of the connecting portion 43 of the path regulating member 40, for example. The holding portion body 53 has an insertion opening 55 that is covered by the lid part 54. The insertion opening 55 is open in a direction orthogonal to the length direction of the wire harness body 11. Note that the transverse sectional shape of the inner surface of the lid part 54 is formed in a shape that follows the outer surface of the exterior member 30, for example.

The lid part 54 is integrally formed with the holding portion body 53, for example. The lid part 54 is joined to the holding portion body 53 by a hinge part 56, for example. The lid part 54 is rotatable between an open position and a closed position covering the insertion opening 55, with the hinge part 56 as the axis. Note that the lid part 54 shown in FIG. 2 is in the closed position, and the lid part 54 shown in FIG. 3 is in the open position.

Also, the lid part 54 has an engaging claw 57. The engaging claw 57 is engaged with a locking part 58 provided on the holding portion 53, in a state where the lid part 54 is in the closed position. The lid part 54 is thereby held in the closed position. Note that the wire harness body 11 is held in the holding portion 52 with the insertion opening 40X oriented to face the lid part 54 side.

As shown in FIGS. 2 and 3, the holding portion 52 has a protrusion 59 that protrudes from the inner peripheral side, that is, the wire harness body 11 side. The protrusion 59 is formed in the holding portion 52 so as to protrude from the inner surface of the lid part 54, for example. One or a plurality of protrusions 59 are provided.

In a state where the lid part 54 is in the closed position, the protrusion 59 is positioned inside the insertion opening 40X of the path regulating member 40. Rotation of the path regulating member 40 relative to the holding portion 52 can thereby be regulated by the protrusion 59. Also, the protrusion 59 fits in the small diameter portion 32 of the exterior member 30. Movement of the exterior member 30 relative to the holding portion 52 is thereby inhibited in the length direction of the exterior member 30.

### Configuration of Bolt Fixing Portion 51

The bolt fixing portion 51 includes a fixing portion body 61 and a fitting part 71 (fitting) that is assembled to the fixing portion body 61.

The fixing portion body 61 is integrally formed with the holding portion body 53, for example. The fixing portion body 61 has an insertion hole 62 through which the bolt B is inserted, and a fitting hole 63 that communicates with the insertion hole 62. Note that, in FIGS. 2, 3 and 4, a width direction X, a depth direction Y and a height direction Z are illustrated as three directions of the fixing member 50 that are orthogonal to each other. The bolt B is inserted in the height direction Z into the insertion hole 62 of the fixing portion body 61. Also, the wire harness body 11 is disposed in the holding portion 52 such that the length direction thereof is in the depth direction Y.

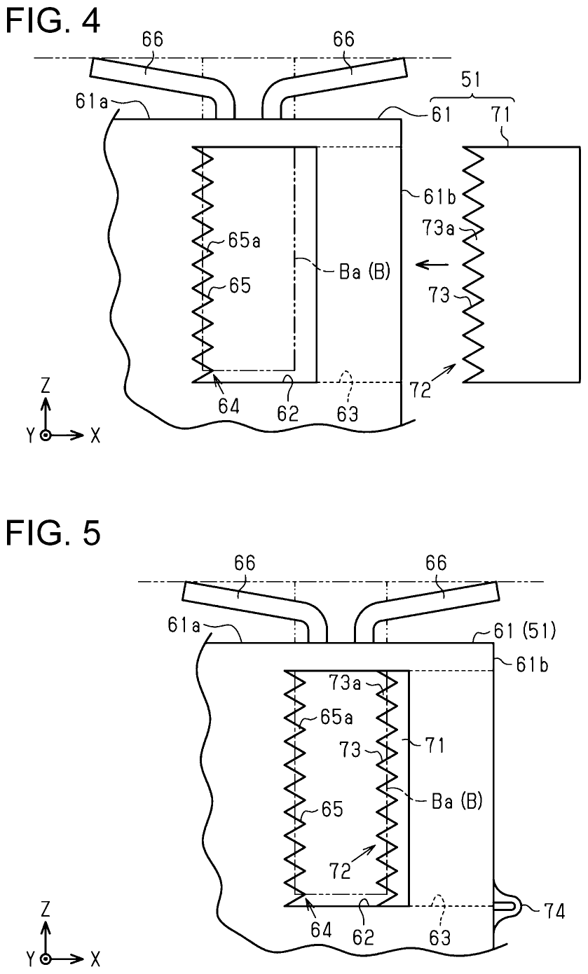

As shown in FIGS. 2 and 4, the fixing portion body 61 has a first side surface 61a that opposes the panel P in a state where the wire harness 10 is attached to the vehicle V. The insertion hole 62 is open in the height direction Z in the first side surface 61a. Note that the insertion hole 62 of the present embodiment is also open on both sides in the depth direction Y.

The fitting hole 63 is open in a direction orthogonal to the height direction Z such as the width direction X, for example. The fixing portion body 61 has a second side surface 61b that intersects the first side surface 61a. The second side surface 61b is orthogonal, for example, to the first side surface 61a. The second side surface 61b is the side surface on the opposite side to the side on which the holding portion 52 is provided in the width direction X. The fitting hole 63 is open in the second side surface 61b. The fitting hole 63 communicates the inner side of the insertion hole 62 with the outer side of the fixing portion body 61 in the width direction X.

The fitting part 71 is press-fit into the fitting hole 63. The fitting part 71 is separate from the fixing portion body 61, for example. Also, the fitting part 71 has a substantially rectangular shape, for example. As the fitting structure of the fitting hole 63 and the fitting part 71 of the present embodiment, it is assumed that, after the fitting part 71 has been press-fit and fixed in the fitting hole 63, the fitting part 71 will not be removed from the fitting hole 63, for example. That is, the size of the fitting part 71 is formed to be equal to or slightly larger than the size of the fitting hole 63, as seen from the width direction X which is the insertion direction of the fitting part 71.

The inner surface of the insertion hole 62 has a side surface 64 that opposes the fitting hole 63 in the width direction X. A first engaging portion 65 (first engagement) capable of engaging a threaded portion Ba (thread) of the bolt B is formed on the side surface 64. Also, the fitting part 71 has a side surface 72 that faces the insertion hole 62. A second engaging portion 73 (second engagement) capable of engaging the threaded portion Ba of the bolt B is formed on the side surface 72. The first engaging portion 65 and the second engaging portion 73 oppose each other across the bolt B in the width direction X.

The first engaging portion 65 and the second engaging portion 73 each have an undulating structure in which recessed portions and raised portions are alternately arranged in the height direction Z. The first engaging portion 65 and the second engaging portion 73 are thereby engaged with the threaded portion Ba of the bolt B in the axial direction. The undulating structure of the first engaging portion 65 is formed throughout from one end of the side surface 64 to the other end in the depth direction Y, for example. Also, the undulating structure of the second engaging portion 73 is formed throughout from one end of the side surface 72 to the other end in the depth direction Y, for example. The second engaging portion 73 protrudes on the inner side of the insertion hole 62 in a state where the fitting part 71 is press-fit and fixed in the fitting hole 63.

Each raised portion 65a of the undulating structure of the first engaging portion 65 extends in a straight line in the depth direction Y, for example. Also, each raised portion 73a of the undulating structure of the second engaging portion 73 extends in a straight line in the depth direction Y, for example. The position of the tip of each raised portion 65a in the width direction X is set according to the diameter of the threaded portion Ba. That is, in the case where the diameter of the threaded portion Ba is uniform in the axial direction, the positions of the tips of the raised portions 65a are aligned in the axial direction of the bolt B. In the case where the diameter of the threaded portion Ba has a tapered shape that decreases in diameter toward the distal end side, the position of the tip of each raised portion 65a is set more inwardly as the raised portion 65a is located further forward in the insertion direction of the bolt B according to the tapered shape. This similarly applies to the raised portions 73a of the second engaging portion 73.

The insertion hole 62 is open on both sides in the depth direction Y. The engaged state of the first engaging portion 65 and the second engaging portion 73 with the threaded portion Ba can thereby be visually confirmed through the opening of the insertion hole 62 in the depth direction Y.

As shown in FIGS. 2 and 3, the fixing portion body 61 has an elastic piece 66 on the first side surface 61a. The elastic piece 66 is provided on each side of the insertion hole 62 in the depth direction Y, for example. The elastic pieces 66 elastically contact the panel P in a state where the wire harness 10 is attached to the vehicle V. That is, the elastic pieces 66 apply an elastic force to the panel P. It thereby becomes possible for the fixing member 50 to suppress rattling.

The manner in which the wire harness 10 is assembled to the panel P will now be described.

First, the wire harness body 11 is assembled to the holding portion 52 of the fixing member 50.

Thereafter, in the fixing member 50 to which the wire harness body 11 has been assembled, the threaded portion Ba of the bolt B is inserted into the insertion hole 62 of the bolt fixing portion 51. The threaded portion Ba is then meshed with the undulating structure of the first engaging portion 65 within the insertion hole 62.

Thereafter, the fitting part 71 is press-fit into the fitting hole 63 and fixed. At this time, the second engaging portion 73 of the fitting part 71 is meshed with the threaded portion Ba. The threaded portion Ba thereby meshes with both the first engaging portion 65 and the second engaging portion 73 while at the same time being sandwiched between the first engaging portion 65 and the second engaging portion 73. Since the fitting part 71 is firmly press-fit and fixed in the fitting hole 63 assuming that the fitting part 71 will not be removed, the engaged state of the first engaging portion 65 and the second engaging portion 73 with the threaded portion Ba is firmly constituted.

The effect of the present embodiment will now be described.

(1) The bolt fixing portion 51 includes the fixing portion body 61 and the fitting part 71 that is assembled to the fixing portion body 61. The fixing portion body 61 has the insertion hole 62 through which the bolt B is inserted, and the fitting hole 63 that communicates with the insertion hole 62 and into which the fitting part 71 is fitted. The insertion hole 62 has the first engaging portion 65 that engages the threaded portion B of the bolt B in the axial direction. Also, the fitting part 71 has the second engaging portion 73 that engages the threaded portion Ba of the bolt B in the axial direction.

According to this configuration, the fixing member 50 is fixed to the bolt B, due to the first engaging portion 65 of the fixing portion body 61 and the second engaging portion 73 of the fitting part 71 that is assembled to the fixing portion body 61 engaging the bolt B. The first engaging portion 65 and the second engaging portion 73 thereby no longer need to be constituted to readily flex in a direction away from each other while contacting the bolt B as in the conventional structure, and, as a result, it becomes possible to inhibit detachment of the fixing member 50 from the bolt B.

(2) The first engaging portion 65 has an undulating structure provided on the side surface 64 of the insertion hole 62. Also, the second engaging portion 73 has an undulating structure provided on the side surface 72 of the fitting part 71. According to this configuration, the first engaging portion 65 and the second engaging portion 73 are respectively engaged with the bolt B due to the undulating structure. It thus becomes possible for the first engaging portion 65 and the second engaging portion 73 to be firmly engaged with the bolt B.

(3) The first engaging portion 65 and the second engaging portion 73 are provided in positions opposing each other across the bolt B. According to this configuration, the first engaging portion 65 and the second engaging portion 73 are engaged on either side of the bolt B, and thus it becomes possible for the first engaging portion 65 and the second engaging portion 73 to be stably engaged with the bolt B.

(4) The fitting part 71 is press-fit into the fitting hole 63. According to this configuration, the fitting part 71 is firmly fitted into the fitting hole 63. Accordingly, it becomes possible for the first engaging portion 65 and the second engaging portion 73 to be firmly engaged with the bolt B.

(5) The fitting part 71 is separate from the fixing portion body 61. According to this configuration, since the fitting part 71 is separate from the fixing portion body 61, it becomes possible to more easily perform the task of fitting the fitting part 71 into the fitting hole 63.

(6) The wire harness 10 includes the exterior member 30 that covers the outer periphery of the wire member 20, and the path regulating member 40 that is attached to the outer periphery of the exterior member 30 and regulates the path of the exterior member 30. The path regulating member 40 has the insertion opening 40X that is open in a direction orthogonal to the length direction of the path regulating member 40 and extends over the entirety of the path regulating member 40 in the length direction. According to this configuration, given that the exterior member 30 covering the wire member 20 and the path regulating member 40 attached to the outer periphery of the exterior member 30 are provided, the weight of the wire harness 10 tends to increase. It thus becomes possible to more markedly obtain the effect of inhibiting detachment of the fixing member 50 achieved by the above configuration.

(7) The holding portion 52 holds the path regulating member 40 in a manner covering the entire circumference of the path regulating member 40. The holding portion 52 has the protrusion 59 that protrudes on the inner peripheral side. Also, the protrusion 59 is positioned inside the insertion opening 40X. According to this configuration, rotation of the path regulating member 40 relative to the holding portion 52 can be regulated by the protrusion 59 of the holding portion 52.

The present embodiment can be modified and implemented as follows.

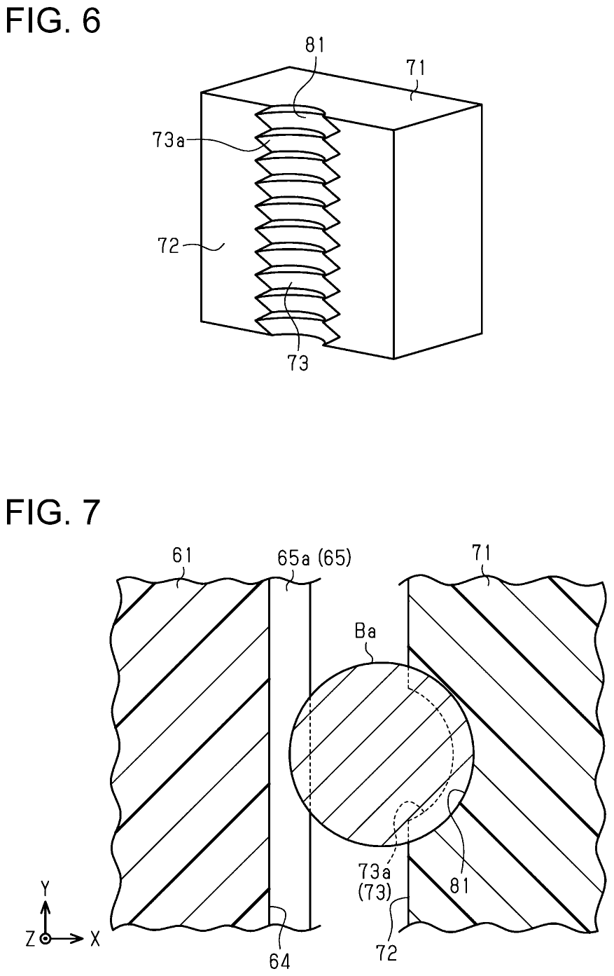

The present embodiment and the following example modifications can be implemented in combination with each other as long as there are no technical inconsistencies.
For example, as shown in FIG. 5, a configuration may be adopted in which the fitting part 71 is joined to the fixing portion body 61 by a hinge part 74. Note that the fixing portion body 61, the hinge part 74 and the fitting part 71 are integrally formed by injection molding, for example. With such a configuration, the fitting part 71 is rotatable from an open position to a closed position of fitting into the fitting hole 63, with the hinge part 74 as the axis, for example. According to such the configuration, since the fixing portion body 61 and the fitting part 71 can be configured as one component, it becomes possible to suppress an increase in the number of components.
For example, as shown in FIGS. 6 and 7, the fitting part 71 may be provided with a circular arc recessed portion 81 (circular arc recess) on the side surface 72. The circular arc recessed portion 81 is formed so as to be recessed in a circular arc shape from the side surface 72, as seen from the axial direction of the bolt B, that is, the height direction Z. The second engaging portion 73 is formed at least on the inner surface of the circular arc recessed portion 81 on the side surface 72 of the fitting part 71. The threaded portion Ba of the bolt B is disposed inside the circular arc recessed portion 81. The threaded portion Ba is then engaged in the axial direction with the second engaging portion 73 formed on the inner surface of the circular arc recessed portion 81. Note that the radius of curvature of the circular arc recessed portion 81 as seen from the height direction Z is set to be equal to the outer diameter of the threaded portion Ba or larger than the outer diameter of the threaded portion Ba.

According to such a configuration, since the circular arc recessed portion 81 is provided with the second engaging portion 73, it becomes possible to increase the contact area between the threaded portion Ba that is disposed inside the circular arc recessed portion 81 and the second engaging portion 73. As a result, it becomes possible for the second engaging portion 73 to be firmly engaged with the bolt B. Also, due to the circular arc recessed portion 81, it becomes possible to inhibit shift of the bolt B in the depth direction Y. Note that, in the case where the fixing member 50 that includes the fixing portion body 61 is formed by injection molding, it is difficult to provide a recessed portion on the side surface 64 of the insertion hole 62. Thus, in the example shown in FIGS. 6 and 7, the circular arc recessed portion 81 is only provided on the side surface 72 of the fitting part 71, and is not provided on the side surface 64 of the insertion hole 62.
The first engaging portion 65 and the second engaging portion 73 of the above embodiment are provided at positions opposing each other across the bolt B, but are not limited thereto, and may be provided in positions not opposing each other.
The fitting part 71 may be fixed in the fitting hole 63 by means other than press fitting, such as bonding, for example.
The configuration of the shape of the fitting part 71 and the like is not limited to the above embodiment, and can be modified as appropriate according to the configuration of the wire harness 10.
The fitting hole 63 of the above embodiment is provided on the opposite side of the holding portion 52 in the width direction X, but is not limited thereto, and the fitting hole 63 may be provided on the holding portion 52 side. In this case, the fitting hole 63 communicates the insertion hole 62 with the inner side of the holding portion body 53 in the width direction X. Furthermore, a configuration may be adopted in which part of the fitting part 71 protrudes on the inner side of the holding portion body 53 from the fitting hole 63, and the region where the fitting part 71 protrudes is positioned inside the insertion opening 40X of the path regulating member 40. According to this configuration, rotation of the path regulating member 40 in the circumferential direction can be regulated by the fitting part 71.
The fixing member 50 of the above embodiment is configured such that the insertion opening 55 of the holding portion body 53 is set to face the panel P side, and the lid part 54 covering the insertion opening 55 opposes the panel P, but is not limited thereto. For example, the insertion opening 55 may be configured to face the opposite side to the bolt fixing portion 51 in the width direction X.
The structure of the path regulating member 40 of the above embodiment can be modified as appropriate. For example, as long as the path regulating member 40 has the insertion opening 40X and has a structure capable of being attached to the outer periphery of the exterior member 30, the remaining structure thereof is not particularly limited.
The protruding portion 45 of the above embodiment may be provided at a position further from the insertion opening 40X than the distal end of the first end portion 41 in the circumferential direction of the path regulating member 40.
The protruding portion 46 of the above embodiment may be provided at a position further from the insertion opening 40X than the distal end of the second end portion 42 in the circumferential direction of the path regulating member 40.
The protruding portions 45 and 46 of the above embodiment may be provided along part of the path regulating member 40 in the length direction.
At least one of the protruding portions 45 and 46 of the above embodiment may be omitted.
The path regulating member 40 of the above embodiment may be configured such that the thickness of the connecting portion 43 in the radial direction changes in the circumferential direction.
The shape of the connecting portion 43 in the path regulating member 40 of the above embodiment is not limited to a circular arc shape, and can be modified to an elliptical arc shape or a U-shape, for example.
In the above embodiment, the path regulating member 40 is given as being more rigid than the exterior member 30, but is not limited thereto, and may have a rigidity that is equal to or less than the exterior member 30. That is, the path regulating member 40 need only act such that the wire harness body 11 is less bendable than when the path regulating member 40 is not attached thereto.
The holding portion 52 may be provided with the protrusion 59 on the holding portion body 53 rather than the lid part 54.
The fixing member 50 may hold a portion of the wire harness body 11 that does not have the path regulating member 40. Also, the path regulating member 40 may be omitted in the wire harness 10 of the above embodiment.
The exterior member 30 of the above embodiment may be provided with a metal layer containing a metal material on the outer surface of the resin corrugated tube, for example.
The exterior member 30 of the above embodiment is not limited to a corrugated tube, and may be an exterior member that does not have a large diameter portion 31 and a small diameter portion 32, for example.
The exterior member 30 of the above embodiment may have a slit that extends in the length direction of the exterior member 30.
In the above embodiment, the wire 21 is given as a high voltage wire, but is not limited thereto, and the wire 21 may be a low voltage wire, for example.
In the wire member 20 of the above embodiment, the electromagnetic shielding member is embodied as the braided member 25, but is not limited thereto. For example, the electromagnetic shielding member of the wire member 20 may be embodied as a metal foil.
The braided member 25 of the wire member 20 of the above embodiment may be omitted.
In the above embodiment, the number of wires 21 constituting the wire member 20 is given as two, but is not limited thereto. The number of wires 21 may be one or may be three or more.
The disposition relationship between the inverter M1 and the high voltage battery M2 in the vehicle V is not limited to the above embodiment, and may be modified as appropriate according to the vehicle configuration.
In the above embodiment, a plurality of in-vehicle devices to which the wire harness 10 is electrically connected are embodied as the inverter M1 and the high voltage battery M2, but are not limited thereto. The plurality of in-vehicle devices to which the wire harness 10 is electrically connected are not particularly limited as long as they are electrical devices installed in the vehicle V.

The embodiment and example modifications disclosed herein are illustrative in all respects, and the present disclosure is not limited to these illustrative examples. That is, the scope of the disclosure is defined by the claims, and all changes that come within the meaning and range of equivalency of the claims are intended to be embraced therein.

What is claimed is:

1. A wire harness comprising:
an electrical wire; and
a fixing member that fixes the electrical wire to an attachment target, wherein:
the fixing member has:
a bolt fixing portion to be fixed to a bolt of the attachment target; and
a holder that holds the electrical wire,
the bolt fixing portion includes:
a fixing portion body; and
a fitting that is assembled to the fixing portion body,
the fixing portion body has:
an insertion hole through which the bolt is to be inserted; and
a fitting hole that communicates with the insertion hole and into which the fitting is fitted,
the insertion hole has a first engagement that engages a thread of the bolt in an axial direction, and
the fitting has a second engagement that engages the thread of the bolt in the axial direction.

2. The wire harness according to claim 1, wherein:
the first engagement has an undulating structure provided on a side surface of the insertion hole, and
the second engagement has an undulating structure provided on a side surface of the fitting.

3. The wire harness according to claim 1,
wherein the first engagement and the second engagement are provided at positions opposing each other across the bolt.

4. The wire harness according to claim 1,
wherein the fitting is press-fit into the fitting hole.

5. The wire harness according to claim 1,
wherein the fitting is separate from the fixing portion body.

6. The wire harness according to claim 1,
wherein the fitting is joined to the fixing portion body by a hinge part.

7. The wire harness according to claim 1, comprising:
an exterior tube covering an outer periphery of the electrical wire; and
a path regulator attached to an outer periphery of the exterior tube and regulating a path of the exterior tube,
wherein the path regulator has an insertion opening open in a direction orthogonal to a length direction of the path regulator and extending over an entirety of the path regulator in the length direction.

8. The wire harness according to claim 7, wherein:
the holder holds the path regulator in a manner covering an entire circumference of the path regulator,
the holder has a protrusion protruding on an inner peripheral side, and
the protrusion is positioned inside the insertion opening.

9. The wire harness according to claim 1, wherein:
the fitting has a circular arc recess recessed in a circular arc shape as seen from the axial direction of the bolt, and
the second engagement is provided in the circular arc recess.
